(19) United States
(12) Patent Application Publication
(10) Pub. No.: US 2006/0009221 A1
(43) Pub. Date: Jan. 12, 2006

(54) Cellular phone which selectively connected with one of mobile telephone systems, its control method, and its program

(75) Inventor: Kazushige Hayashi, Higashi-Osaka City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/091,703

(22) Filed: Mar. 29, 2005

(30) Foreign Application Priority Data
Mar. 30, 2004 (JP) 2004-100375

(51) Int. Cl. H04Q 7/20

(52) U.S. Cl. 455/435.3

(57) ABSTRACT

The present invention provides a cellular phone which prevents the problem of entering a state where it cannot respond to arrival of a call from the presently-used system while trying to connect with a system which is higher priority than the presently-used system. The system information table stores a list of systems connected along with their priorities, and the presently-used system register saves the information of the presently-used system which is connected to at the end. The scan control section indicates capturing a higher priority system to the system capture control section using scan pointer register as a working memory in between times where the cellular phone stands by with the presently-used system. During the process, an interruption standby control section controls the cellular phone to be a state of standby connecting with the presently-used system again in every sequential failure of capturing the predetermined number of higher priority system.

### CROSS REFERENCE TO RELATED APPLICATIONS

This application is based upon and claims priority of Japanese Patent Application No. 2004-100375, the contents of which are incorporated herein by reference.

### BACKGROUND OF THE INVENTION

1. Field of the Invention

The present invention relates to a cellular phone which selectively connects with one of mobile telephone systems, and especially relates to the technology to reduce the decrease in the availability caused when the connection is switched.

2. Description of the Related Art

The spread of the mobile telephone service is remarkable recently, and two or more carriers provide a variety of mobile telephone systems. As a result, a user is given a variety of choices such as different coverage, different use charge, and different additional functions, etc. Under that circumstance, a cellular phone which is able to be selectively connected with systems of two or more mobile telephone services provided by different carriers or based on different standards according to the user's choice comes into practical use (hereafter, the system is called “mobile telephone system” or “system”). The user can use a mobile telephone service which is connected with a suitable system according to location of the moment, purpose of use, or use charge, even though the user carries only one cellular phone.

The method of system connection change in such a cellular phone is disclosed in, for example, the Japanese laid open patent TOKKAI-HEI 11-298964(hereafter called “Patent Document 1”). Patent Document 1 explains a cellular phone which can switch between the mobile communication system of GSM (Global Systems for Mobile communications) and the one of PHS (Personal Handy phone System). The cellular phone, by priority, tries to register the position to the PHS, which is usually narrow coverage but is also cheaper use charge than the GSM, when its power supply is turned on. At the same time, it receives a control signal from a control channel of the GSM, and records the control channel. The recording is done when succeeding in positional registration to the PHS (FIG. 3 and FIG. 6 in Patent Document 1).

Positional registration to the GSM is tried through the control channel which has already been recorded at the moment of going out of the range of the PHS. Because of that, the use of the GSM is enabled at the shortest time to have omitted time to look for the control channel (FIG. 2 of Patent Document 1).

However, because the cellular phone which operates according to the method of switching of the above mentioned art periodically tries to connect to the PHS, it is likely to enter a state where it cannot respond to arrival of a call from the GSM. If it enters such a state, a contradiction wherein a calling party who calls the phone via the GSM gets a message which shows that the phone is the out of the range of the GSM despite of the fact that it is within the range is caused. The cellular phone according to the above mentioned art has the problem that it cannot deal with the contradiction effectively.

In the case that only two systems are switched as the example mentioned above, the problem might not come to the forefront because the period of time while trying to register a position is short. A circuit to process two systems completely concurrently is installed so that the problem can be avoided. However, if the number of systems to be switched is much more, it is not realistic to install circuits to process all systems completely concurrently. Therefore, the period of time while trying to register a position becomes much longer, and the problem mentioned above comes to the forefront.

### SUMMARY OF THE INVENTION

In view of the foregoing circumstances, in accordance with embodiments of the present invention, a cellular phone, its control method, and its program are provided which reduce the decrease in availability occurring while trying to connect with a system which is of a higher priority than the presently-used system, that is to say, entering the state where it cannot respond to arrival of a call from the presently-used system.

In order to solve the problems described above, the preferred embodiment of the invention of a cellular phone which stands by with a presently-used system after selecting one from mobile telephone systems comprises following: a system information storage medium to store the priority level of each of the mobile telephone systems, a scanning means for trying to capture a higher priority mobile telephone system than the presently-used system after interrupting the standby of the presently-used system, and an interruption standby means for reactivating the standby of the presently-used system after interrupting the trial of the capture of a higher priority mobile telephone system if the capture of a higher priority mobile telephone system is tried repeatedly until a predetermined condition becomes satisfied.

Further, the interruption standby means also reactivates the standby of the presently-used system after interrupting the trial of the capture of a higher priority mobile telephone system if the capture of a higher priority mobile telephone system is tried repeatedly until the capture of a higher priority mobile telephone system fails continuously within predetermined counts or a predetermined period of time.

In accordance with the preferred embodiment of the present invention, the problem of entering a state where the phone cannot respond to arrival of a call from the presently-used system is reduced because the cellular phone stands by with the presently-used system by interrupting the trial to capture of a higher priority system. Especially, if the presently-used system stands by after interrupting in much shorter intervals than continuous time of calling, the problem of entering a state where the phone cannot respond to arrival of a call from the presently-used system is almost completely resolved.

Further, the interruption standby means also reactivates the trial of the capture of a higher priority mobile telephone system if there is no call from the presently-used system for a predetermined period of time. In accordance with the preferred embodiment, all of the higher priority systems are scanned without omission because the trial to capture a higher priority system is reactivated when the fact that there is no call is ascertained while in the standby state for the presently-used system between the trials to capture a higher priority system.

Further, the scanning means also tries to capture a lower priority mobile telephone system than the presently-used system if the standby of the presently-used system fails after the capture of a higher priority system fails. In accordance with the preferred embodiment, greatest number of systems are available by virtue of trying to capture a lower priority system if the phone is not able to return to the presently-used system after scanning higher priority mobile telephone systems.

In order to solve the problems described above, the preferred embodiment of the invention of a control method of a cellular phone which stands by with a presently-used system after selecting one from mobile telephone systems, wherein the cellular phone stores each priority level of the mobile telephone systems comprises the following: a scanning step for trying to capture a higher priority mobile telephone system than the presently-used system after interrupting the standby of the presently-used system, and an interruption standby step for reactivating the standby of the presently-used system after interrupting the trial to capture the higher priority mobile telephone system if the capture of the higher priority mobile telephone system is tried repeatedly until a predetermined condition becomes satisfied.

Further, the interruption standby step also reactivates the standby of the presently-used system after interrupting the trial of the capture of a higher priority mobile telephone system if the capture of a higher priority mobile telephone system is tried repeatedly until the capture of a higher priority mobile telephone system fails continuously within predetermined counts or a predetermined period of time.

Further, the interruption standby step also reactivates the trial to capture a higher priority mobile telephone system if there is no call from the presently-used system for a predetermined period of time.

Further, the scanning step also tries to capture a lower priority mobile telephone system than the presently-used system if the standby of the presently-used system fails after the capture of the higher priority system fails. In accordance with the preferred embodiment, by operating a cellular phone according to this control method, effects similar to the above-mentioned are achieved.

In order to solve the problems described above, the preferred embodiment of the invention of a computer executable program to control a cellular phone which stands by with a presently-used system after selecting one from mobile telephone systems, wherein the cellular phone stores the priority level of each of the mobile telephone systems, and makes a mobile phone execute at least one of the steps mentioned above.

In accordance with the preferred embodiment, by controlling a cellular phone using these programs, effects similar to the above-mentioned are achieved.

### BRIEF DESCRIPTION OF THE DRAWING

The above and other objects and advantages of the present invention will become apparent and more readily appreciated from the following description of the preferred embodiments taken in conjunction with the accompanying drawings, of which:

FIG. 1 is a function block diagram of a cellular phone which is preferably used in accordance with embodiments of the present invention.

FIG. 2 is an illustration showing data structure and contents of system information table.

FIG. 3 is a flow chart showing system switching process which the cellular phone executes.

FIG. 4 is an illustration of cellular phone's operating environment.

FIG. 5 is an illustration of the sequence of system switching operation on the cellular phone's operating environment.

### DETAILED DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

The preferred embodiment of the invention of a cellular phone stands by with a presently-used system after selecting one as the presently-used system from several mobile telephone systems. The cellular phone manages the priority levels of the mobile telephone systems, and it periodically tries to connect with a system which has been given higher priority than a presently-used system (hereafter called “higher priority system”) by interrupting the standby of the presently-used system. During the process, the cellular phone tries to connect with the higher priority system the predetermined number of times sequentially. Then, the phone reactivates the connection of the presently-used system and stands by with it for the predetermined period of time. If there is no call during the standby, it tries to capture another higher priority system.

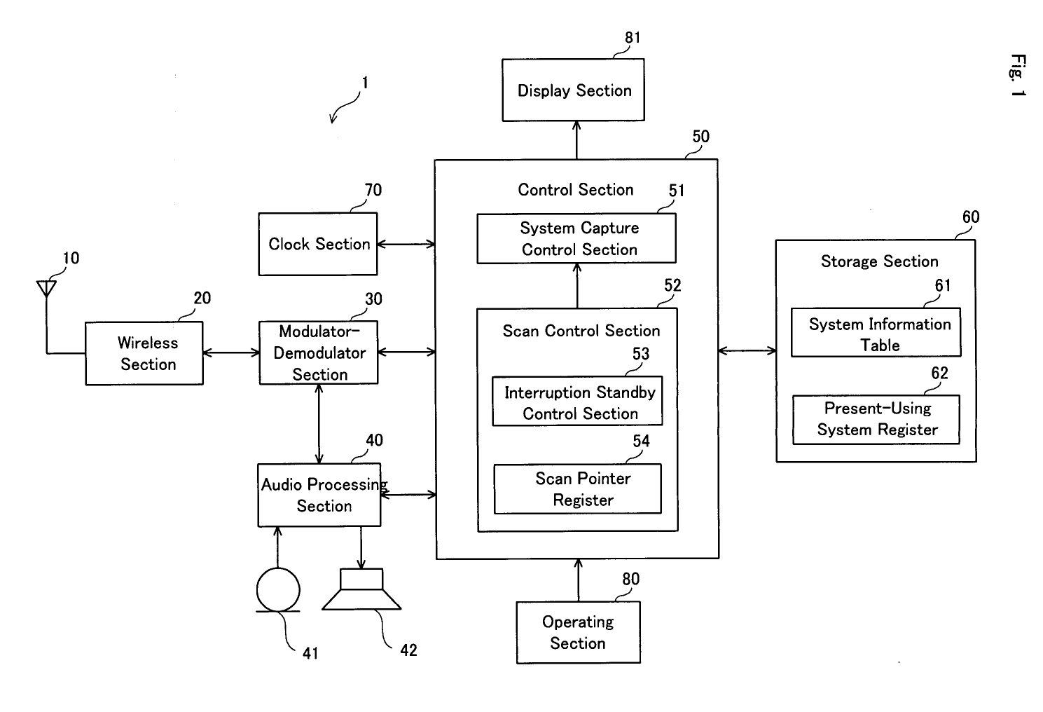

Embodiments of the present invention will now be described below with reference to FIGS. 1 to 5.

<Overall Configurations>

FIG. 1 is a function block diagram of a cellular phone 1. The cellular phone 1 has an antenna 10, a wireless section 20, a modulator-demodulator section 30, an audio processing section 40, a microphone 41, a receiver 42, a control section 50, a storage section 60, a clock section 70, an operating section 80, and a display section 81.

The wireless section 20 amplifies a received signal received by the antenna 10, and a modulator-demodulator section 30 demodulates the amplified received signal into a control data signal and a received audio signal. The control section 50 controls the connection with a system according to the control data signal. The audio processing section 40 converts the received audio signal from digital to analog then outputs from the receiver 42. The audio processing section 40 converts a telephone audio signal from the microphone 113 from digital to analog. The modulator-demodulator section 30 modulates the telephone audio signal which is converted from digital to analog and a transmission data signal which is given from the control section 50 into a transmission signal. The wireless section 20 amplifies the transmission signal and transmits it from the antenna 10.

Here, a wireless section 20, a control section 50, and a modulator-demodulator section 30 adapt to all transmission formulae and frequencies which are used by systems which the cellular phone is able to connect with, and the cellular phone connects with one of the systems by switching transmission formulae and frequencies. The configuration itself to adapt to systems are not a specific part of the present invention, therefore the explanation in detail will be omitted. General configuration will be used properly.

The clock section 70 clocks the present time and outputs it to the control section 50. The display section 81 is implemented in a color liquid crystal panel, DMD (Digital Mirror Device), organic electroluminescence panel, PDP (Plasma Display Panel), or the like, and it displays the current time, remaining amount of battery, radio wave strength, and so forth. The operating section 80 comprises ten keys, off hook key, and on hook key, and they are used for dial operation, ring-up operation, ring-off operation, etc.

The control section 50 is implemented in a CPU (Central Processing Unit), a ROM (Read Only Memory), a RAM (Random Access Memory), etc, and the overall operation of the cellular phone 1 is controlled by the CPU executing a program which is stored in the ROM and uses the RAM as a working memory. Especially, an operation mentioned below is a specific part of the present invention. A system capture control section 51 tries the capture of a system which is indicated by a scan control section 52. Here, capture means the case where a control signal from the system is received and the reception is succeeded.

The scan control section 52 indicates capturing higher priority systems one by one according to the order of priority to the system capture control section 51 using scan pointer register 54 as a working memory in between times where the cellular phone 1 stands by with the presently-used system. During the process, an interruption standby control section 53 controls the cellular phone 1 to enter a state of standby connected with the presently-used system again in every sequential failure of capturing the predetermined number of higher priority system.

The storage section 60 is implemented in a memory like a flash memory, and a system information table 61 and a presently-used system register 62 are in it. The system information table 61 stores a list of systems to which the cellular phone 1 is able to connect along with their priorities, and the presently-used system register 62 saves the information of the presently-used system which is connected to at the end.

<Data Structure>

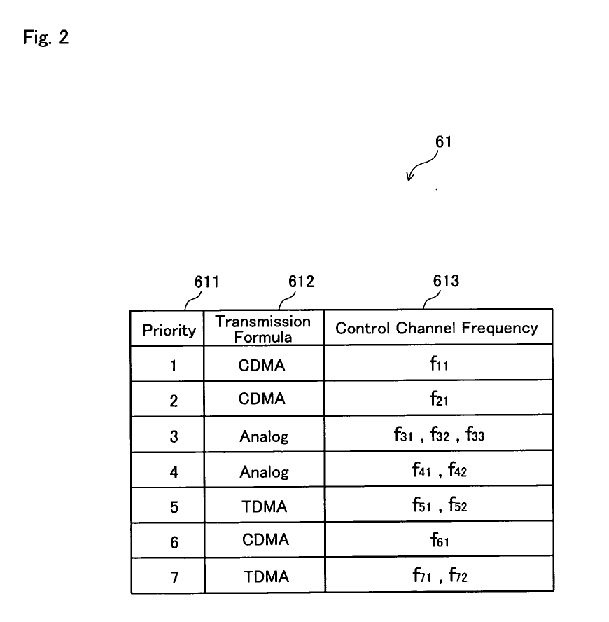

FIG. 2 is an illustration showing data structure and contents of the system information table 61 which is set up in the storage section 60. Each row of the system information table 61 corresponds to one of the systems. A priority row 611 retains a priority which is given to the system. A transmission formula row 612 retains a transmission formula which the system uses to transmit. A control channel frequency row 613 retains a control channel frequency or control channel frequencies which the system uses. Here, although the case that all priorities are different is shown as the embodiment for the sake of simplicity, same priorities might be given to some systems as well.

Various cases are assumed to determine the priorities. The priorities can be set up by the cellular phone's user to connect to the well-used system by priority according to use charge, additional function, etc. Besides, in the case of being provided by carriers of mobile telephone service, the priorities can be set up in the order from the system of the carrier, the systems of carriers which are affiliated on roaming, and then, the systems of others. The embodiment of the present invention does not limit the determination of the priorities.

<Operation>

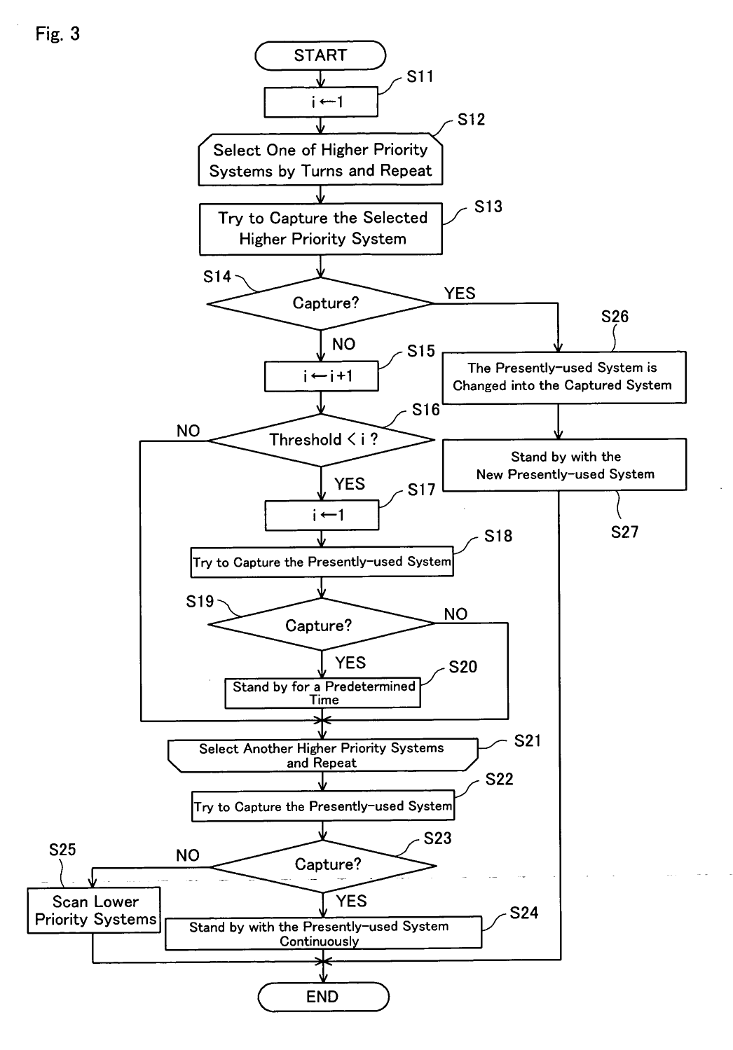

FIG. 3 is a flow chart showing the system switching process which the cellular phone 1 executes. The process is periodically executed during the ordinary standby with the presently-used system unless the priority of the presently-used system is 1. In addition, it can be executed when the cellular phone 1 is turned on, or when the connection with the presently-used system is recovered from the state where it is in the out of all the system's range. During the process, working variable “i” is used in the interruption standby control section 53.

The interruption standby control section 53 makes “i” 1 (S11). The scan control section 52 scans higher priority systems by increasing a scan pointer one by one within the range of higher system's priority (from 1 to −1, which is the priority of the presently-used system) (S13-S21).

The scan control section 52 refers to the system information table 61 about the transmission formula and the control channel frequency of the system which is pointed by the scan pointer, and it indicates the capture of the system by informing the system capture control section 51 about the contents referred to. The system capture control section 51 tries the reception of a control signal from the control channel of the system by controlling the wireless section 20 and the modulator-demodulator section 30 according to the informed contents, and if the control signal is received, it registers the position to the system (S13).

If the system is captured (Sl4:YES), the presently-used system is updated by registering the priority of the captured system to the presently-used system register 62 (S26), and the cellular phone 1 stands by with the updated presently-used system (S27). If the system is not captured (S14:NO), the interruption standby control section 53 increases “i” by 1. Then, if “i” becomes more than a predetermined threshold (S16:YES), it resets “i” as 1 (S17), refers to the system information table 61 regarding the transmission formula and the control channel frequency of the presently-used system, and indicates the capture of the system by informing the system capture control section 51 about the contents referred to. The system capture control section 51 tries the capture of the presently-used system according to the informed contents (S18). Then, if it is captured (Sl9:YES), the cellular phone stands by with the presently-used system for a predetermined period of time (S20). Hereafter, this standby is called “interruption standby” to distinguish from ordinary standby.

After that, the scan pointer is increased by 1, and the next higher priority system is handled. When all higher priority systems are scanned, the system capture control section 51 tries the capture of the presently-used system. If it is captured (S23:YES), the cellular phone 1 returns to the state of ordinary standby with the presently-used system (S24). If it can not return to the standby with the presently-used system, the system capture control section 51 tries the capture of a system by scanning lower priority systems (S25). Though it is not shown in the figure, if capture of all lower priority systems fails, the cellular phone 1 displays that it is in the out of the range. Also, while scanning lower priority systems, the cellular phone 1 may enter a state of standby connected with the presently-used system in every sequential failure of capturing the predetermined number of systems.

### CONCRETE EXAMPLE

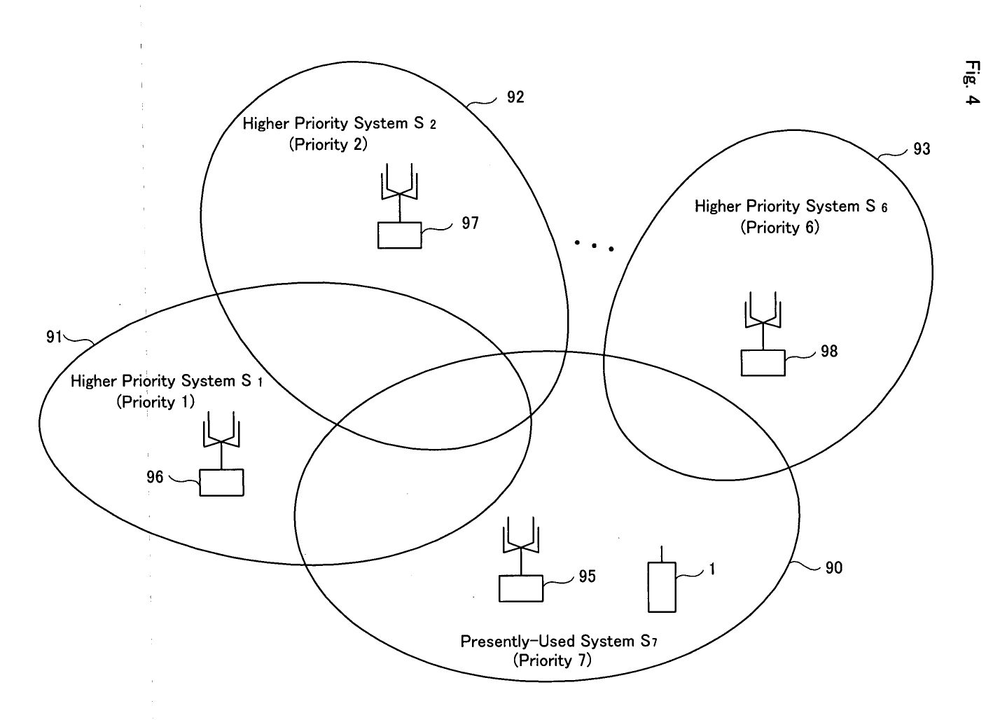

FIG. 4 is an illustration of a cellular phone's operating environment, and is drawn corresponding to the illustration showing contents of the system information table 61 (referring to FIG. 2). The cellular phone 1 is within the range of the presently-used system S7 (Priority 7)'s service area 90, the position of it is registered to the base station 95 and is in a state of an ordinary standby. Here, the cellular phone 1 is in the out of the range of the higher priority systems S1-S6 (Priority 1-6)'s service areas 91-93, it can not receive a control signal from each of the base stations 96-98.

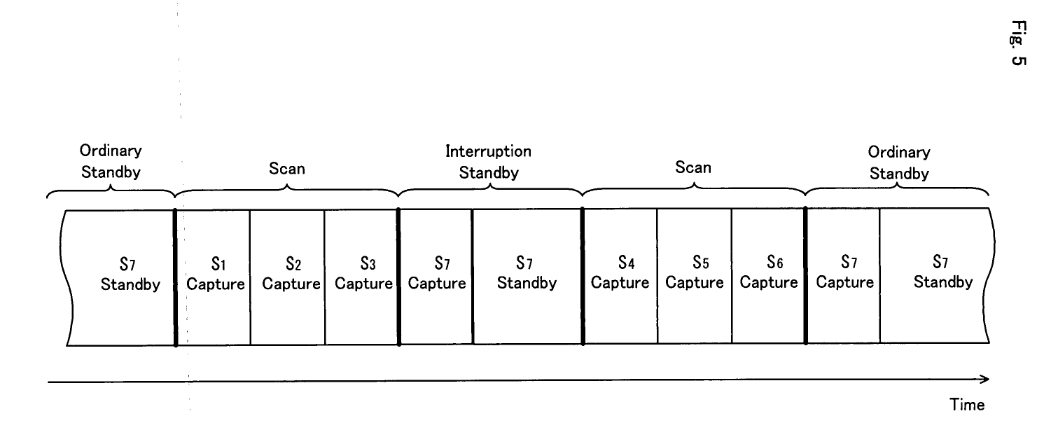

FIG. 5 is an illustration of the operating sequence of system switching process on this operating environment. The threshold of “i” to activate an interruption standby is 3 in this example. At first, the cellular phone 1 is in a state of an ordinary standby with the presently-used system S7. The targets of higher priority systems to scan are S1-S6 at this time. The cellular phone 1 tries to capture higher priority systems S1, S2, and S3 in that order. When capture of all of these three higher priority systems fails sequentially, the cellular phone 1 stands by as an interruption standby capturing the presently-used system S7. If it confirms that there is no call on the presently-used system, then it tries to capture higher priority systems S4, S5 and S6 in that order. Then, if it can not capture any of them, it returns to the state of an ordinary standby of the presently-used system S7 again.

If it is confirmed that there is a call when in the interruption standby, a normal arrival operation is surely done, and an arrival call is noticed to the user, for example by ringing a ringer. In general, a call from a mobile telephone service lasts for a few seconds to several seconds. Then, the threshold of the time limit for scanning higher priority systems continuously is taken on as a value much less than the continuous time of a call, so that the cellular phone 1 can stand by with the presently-used system once at least during the call. Therefore, the problem where it cannot respond to an arrival of a call during scanning higher priority systems is almost completely resolved.

Though, in the embodiment mentioned above, an interruption standby starts to be activated referencing the upper limit number to scan higher priority systems continuously. Alternatively, it may start to be activated referencing the upper limit time to scan higher priority systems continuously. If so, a timer will be adopted instead of the working variable “i”, S11 and S15 will be modified as a restart operation of the timer, and S16 will be modified as a judge operation of the timer's completion.

Moreover, in the embodiment mentioned above, all systems that the cellular phone 1 can connect to are stored as one in the system information table 61, but they may be stored separately in several system information tables in accordance with the geographic position. If so, the load of the scan process can be reduced because the number of higher priority systems to scan can be reduced appropriately according to the geographic position. The similar effects can be achieved as compartmentalizing the system information table 61 according to the geographic position instead of setting up some discrete system information tables.

<Conclusion>

As described above, in accordance with the cellular phone of the present invention, it stands by with the presently-used system by interrupting during scanning higher priority systems in every predetermined period of time, so the problem entering the state where it cannot respond to arrival of a call from the presently-used system is reduced. Especially, if the presently-used system stands by after interrupting in much shorter intervals than the continuous time of calling, the problem is almost completely resolved.

<Other Alternations>

Though the present invention is explained based on the embodiment mentioned above, the present invention is not limited to it needless to say. Some cases like mentioned below are also included.

The present invention can be a computer program to achieve as using a CPU to control a cellular phone, or it can be a digital signal expressing the program instead of the method mentioned in the above embodiment. Or, it can be a recording medium recording the program or the digital signal, like a flexible disk, a hard disk, a CD, an MO (Magneto-Optical disk), a DVD, a BD (Blu-ray Disc), a semiconductor memory, etc.

Further, the present invention can be the computer program or the digital signal transmitted through a network such as a telecom line, a wireless or wired communication line, the internet, or the like. In addition, the program and the digital signal can be transferred by recording in the recording medium or through the network, then they can be operated in another independent cellular phone.

### POSSIBILITY OF USE ON INDUSTRY

The cellular phone of the present invention suits a cellular phone used in the area where two or more mobile telephone services provided, and also, it properly suits a cellular phone having a roaming function.

Although a few preferred embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A cellular phone which stands by with a presently-used system after selecting one from at least two mobile telephone systems, the cellular phone comprising:
a system information storage medium to store each priority level of the mobile telephone systems,
a scanning means for trying to capture a higher priority mobile telephone system than the presently-used system after interrupting the standby of the presently-used system, and
an interruption standby means for reactivating the standby of the presently-used system after interrupting the trial of the capture of a higher priority mobile telephone system if the capture of a higher priority mobile telephone system is tried repeatedly until a predetermined condition becomes satisfied.

2. The cellular phone according to claim 1, wherein the interruption standby means reactivates the standby of the presently-used system after interrupting the trial of the capture of a higher priority mobile telephone system if the capture of a higher priority mobile telephone system is tried repeatedly until the capture of a higher priority mobile telephone system fails continuously within predetermined counts or a predetermined period of time.

3. The cellular phone according to claim 1, wherein the interruption standby means reactivates the trial of the capture a higher priority mobile telephone system if there is no call from the presently-used system for a predetermined period of time.

4. The cellular phone according to claim 1, wherein the scanning means tries to capture a lower priority mobile telephone system than the presently-used system if the standby of the presently-used system fails after the capture of a higher priority system fails.

5. A control method of a cellular phone which stands by with a presently-used system as selecting one from mobile telephone systems, wherein the cellular phone stores the priority level of each of the mobile telephone systems, the control method comprising:
a scanning step for trying to capture a higher priority mobile telephone system than the presently-used system after interrupting the standby of the presently-used system, and
an interruption standby step for reactivating the standby of the presently-used system after interrupting the trial of the capture of a higher priority mobile telephone system if the capture of a higher priority mobile telephone system is tried repeatedly until a predetermined condition becomes satisfied.

6. The control method according to claim 5, wherein the interruption standby step reactivates the standby of the presently-used system after interrupting the trial of the capture of a higher priority mobile telephone system if the capture of a higher priority mobile telephone system is tried repeatedly until the capture of a higher priority mobile telephone system fails continuously within predetermined counts or a predetermined period of time.

7. The control method according to claim 5, wherein the interruption standby step reactivates the trial to capture a higher priority mobile telephone system if there is no call from the presently-used system for a predetermined period of time.

8. The control method according to claim 5, wherein the scanning step also tries to capture a lower priority mobile telephone system than the presently-used system if the standby of the presently-used system fails after the capture of the higher priority system fails.

9. A computer executable program to control a cellular phone which stands by with a presently-used system after selecting one from at least two mobile telephone systems, wherein
the cellular phone stores the priority level of each of the mobile telephone systems, and
the program makes the mobile phone execute the steps according to claim 5.

10. A computer executable program to control a cellular phone which stands by with a presently-used system after selecting one from at least two mobile telephone systems, wherein
the cellular phone stores the priority level of each of the mobile telephone systems, and
the program makes the mobile phone execute the steps according to claim 6.

11. A computer executable program to control a cellular phone which stands by with a presently-used system after selecting one from at least two mobile telephone systems, wherein
the cellular phone stores the priority level of each of the mobile telephone systems, and
the program makes the mobile phone execute the steps according to claim 7.

12. A computer executable program to control a cellular phone which stands by with a presently-used system after selecting one from at least two mobile telephone systems, wherein
the cellular phone stores the priority level of each of the mobile telephone systems, and
the program makes the mobile phone execute the steps according to claim 8.
